(19) United States
(12) Patent Application Publication
(10) Pub. No.: US 2009/0150274 A1
(43) Pub. Date: Jun. 11, 2009

(54) Distribution of a monetary fund

(75) Inventors: Nigel Frudd, London (GB); Michael Tyler, Chislehurst (GB)

Correspondence Address: KNOBBE MARTENS OLSON & BEAR LLP, 2040 MAIN STREET, FOURTEENTH FLOOR, IRVINE, CA, 92614, US

(73) Assignee: LTIPCO Limited, London (GB)

(21) Appl. No.: 12/001,495

(22) Filed: Dec. 11, 2007

(51) Int. Cl. G06Q 40/00

(52) U.S. Cl. 705/35

(57) ABSTRACT

A method of allocating units in a monetary fund includes the steps of: determining an initial unit allocation for each policyholder of the fund, and periodically allocating extra units to surviving policyholders of the fund. The number of extra units being allocated is based on a probability of availability of units in the fund arising from deceased policyholders.

### FIELD OF THE INVENTION

The present invention relates to distribution of a monetary fund.

### BACKGROUND OF THE INVENTION

In the UK, the average life expectancy of a 40 year old alive today is 88 years; he or she has approximately a 1 in 2 chance of living to 90 and a 1 in 10 chance of reaching 100. However, individual and corporate retirement provisions are often inadequate to maintain a satisfactory standard of living in old age. It is estimated, for example, that 60% of those aged 35 and over are not saving sufficiently to ensure a comfortable retirement.

As a result of the increase in longevity, the number of people aged 75 and over in the UK is expected to rise from 4.7 million in 2006 to 7.2 million in 2026, a rise of 54%.

The cost of long lives is placing a significant strain on the State pension scheme and company pension schemes. In 1980 the value of the State pension amounted to over 20% of average earnings. By 2024, however, it is estimated that the State pension will amount to approximately 10% of average earnings.

Many people who live into their 80's and 90's require various levels of assistance, including, in some cases, the need for full time residential care. As a result, those who live to very old age can often spend their last years in financial dependency or poverty.

There is a wide variety of products available to individuals to meet their financial needs. Short-term savings provide security and liquidity, investments can provide higher returns, with tax benefits if so structured, pensions provide an income after retirement, again with tax advantages, while life assurance enables dependents to be provided for on death.

However, a clear gap exists. No product has yet been offered specifically to provide financial cover for the growing prospect of living into very old age, with its attendant problems and expenses.

### SUMMARY OF THE INVENTION

According to one aspect of the invention there is provided a method of allocating units in a monetary fund which comprises the steps of: determining an initial unit allocation for each policyholder of the fund; periodically allocating extra units to surviving policyholders of the fund, wherein the number of extra units being allocated is based on a probability of the availability of units in the fund arising from deceased policyholders.

Another aspect of the invention provides a method of distributing a monetary fund which comprises the steps of: periodically determining a number of extra units in the fund to be allocated based on a probability of the availability of units in the fund arising from deceased policyholders; distributing the extra units amongst surviving policyholders; making periodic payments to a policyholder based on their unit allocation at the time a payment is made; and adjusting their unit allocation.

It is a significant advantage of the distribution system discussed herein that, based on expected mortality rates, fund growth and the periodic payment schedule, payments to surviving policyholders will rise with age. This makes the distribution system particularly attractive for investors expecting to live to an old age.

Preferably, there is a minimum period as a policyholder of the fund after entry during which extra units are allocated but in which no payments are received. Payments are made for a set period after a vesting age, for example for twenty-one years. In the following description, the units are referred to as birthday units because in the preferred embodiment they are allocated to each policyholder at their birthday.

For a better understanding of the present invention and to show how the same may be carried into effect, reference will now be made by way of example to the accompanying drawings, in which:

FIG. 1 is a schematic block diagram of a distribution system;

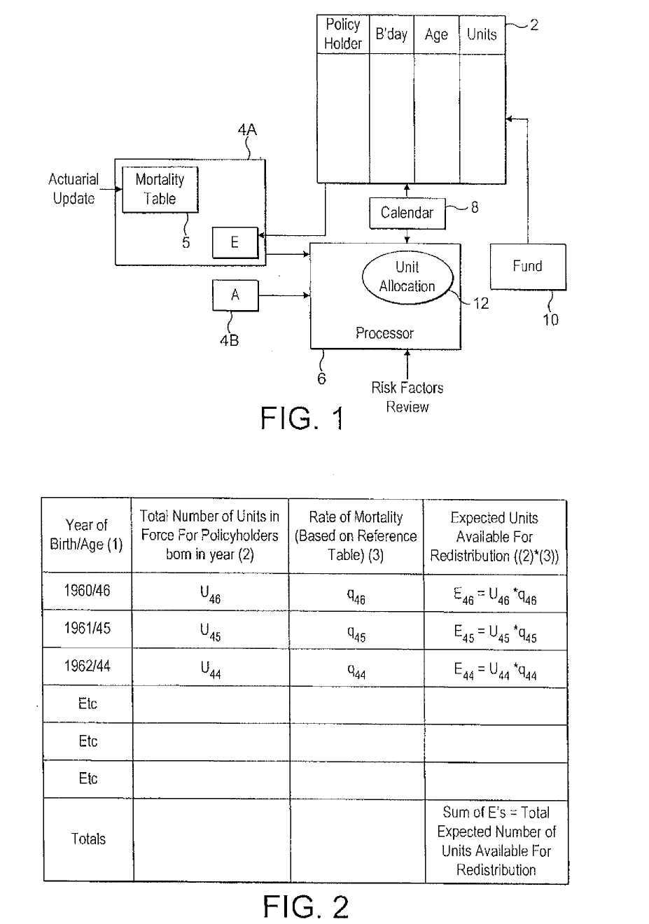

FIG. 2 is a table illustrating calculation of the number of extra units to be allocated;

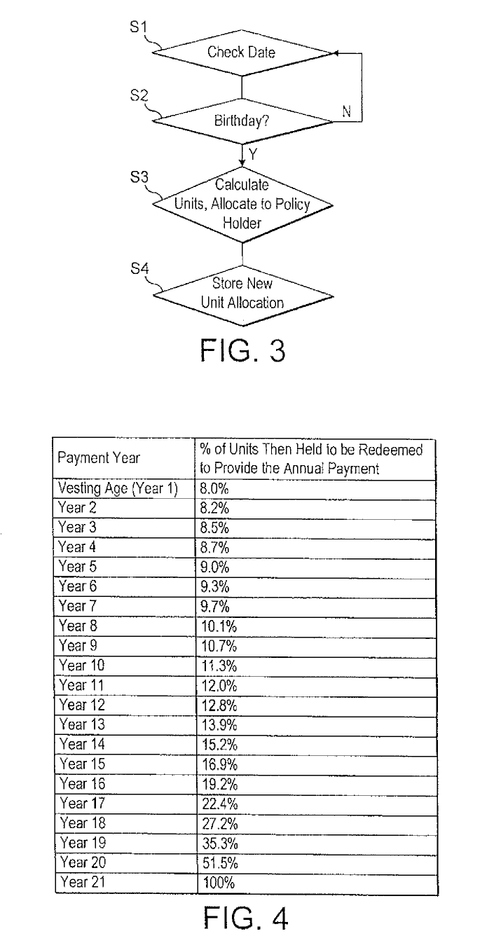

FIG. 3 is a flow chart illustrating operation of a process to allocate units;

FIG. 4 is a table showing a schedule of adjustments when payments are made;

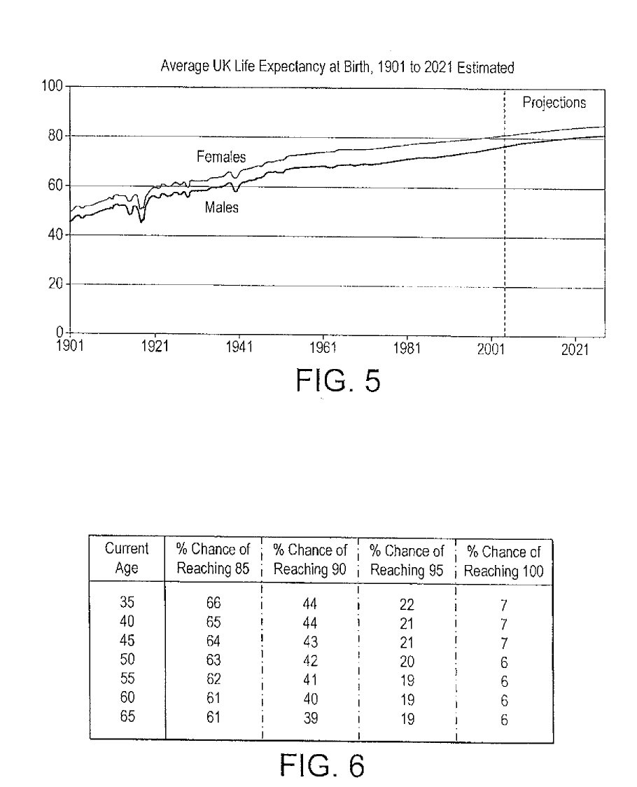

FIG. 5 is a graph illustrating average UK life expectancy;

FIG. 6 is a table illustrating prospects of reaching advanced ages in the Western world;

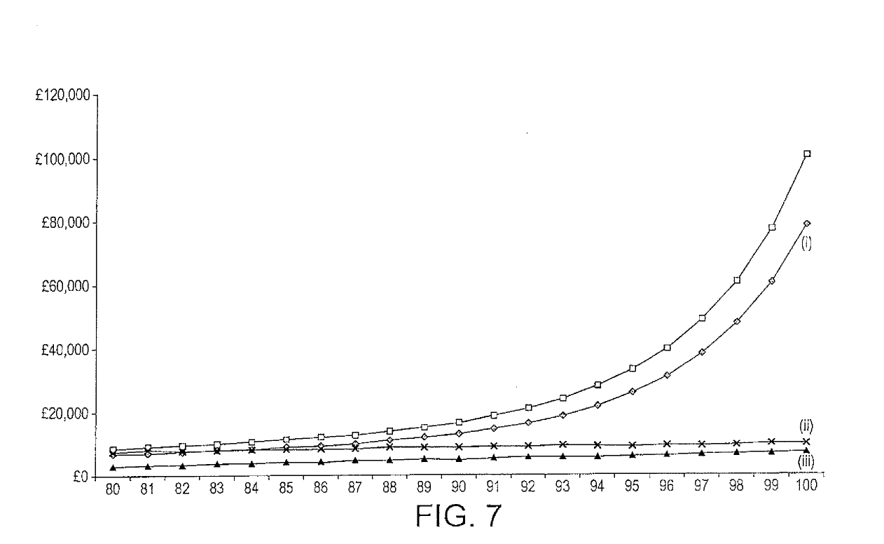

FIG. 7 is a graph illustrating the performance of the distribution system described herein in comparison to existing investment models; and

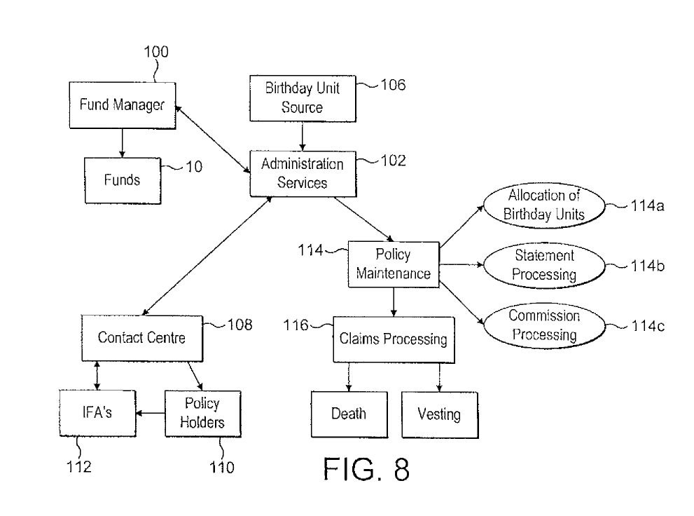

FIG. 8 is a schematic diagram of a high level operating model of the distribution system described herein.

In the following described embodiment of a monetary fund management scheme, all policyholders participate on a pooled basis to share the aggregate funds released on death from deceased policyholders (net of explicit charges) amongst the surviving population. The distribution is calculated on an equitable basis depending on:

1. The likelihood of survival of an individual.

2. The proportion of the individual holding compared with the total.

A mathematical approach ensures this equitable distribution throughout the population. In addition, it uses a specific schedule of factors designed to produce a monotonic increasing series of payments during the period of disinvestment (see FIG. 4 discussed later).

The combination of the mutual nature of the policyholder funds together with a specific method for maintaining an equitable distribution between participants and the payout schedule creates a unique product design. The distinguishing benefit of the scheme is that it provides a financially efficient solution for an individual whose lifespan exceeds the average for his peer group.

The scheme is supported by an administrative system that ensures that the re-distribution of funds is achieved equitably through the allocation of birthday units which are allocated on the birthday of surviving policyholders.

The policyholder acquires the right to a series of up to 21 annual payments commencing on a chosen birthday (e.g. 75 or 80) and continuing annually on their birthday thereafter contingent only on their survival to each birthday. The actual payment will be determined at that time by reference to a fixed schedule of disinvestment factors which are applied consecutively at each birthday to the accumulated notional fund allocated to the policyholder.

There are two important aspects of the distribution system described herein. The first is the mechanism by which units are allocated to policyholder and the second is the payment regime. The unit allocation mechanism is discussed first. The accumulated notional fund builds up from a combination of the original net sum invested together with investment gains and also additional (birthday) units allocated at each birthday representing the equitable distribution of units previously held in the notional funds of deceased policyholders. The equitable distribution of units is achieved by considering the total number of units that would be expected to become available through deaths within the whole population (this is called “E”). This is calculated by reference to an appropriate mortality table 5 as determined by an appointed actuary and allowing for risk factors such gender and duration since purchasing the policy together with weightings to account for individual notional fund size. This is compared with the actual number of units released through deaths in the period of analysis (denoted as “A”). FIG. 1 is a schematic block diagram of components of a distribution system for use in distributing an investment fund. The system comprises a database 2 which holds details of policyholders, holding for each policyholder their identifying details, their birthday, their current age and their current allocation of units, together with any other relevant information, significantly including deaths. A first memory 4A holds a mortality table 5, discussed in more detail below with reference to FIG. 2 and the redistribution parameter E also discussed in more detail below. The mortality table 5 can be updated from time to time. A processor 6 has access to the database 2 and memories 4A, 4B. A second memory 4B holds the parameter A based on actual experience. It will readily be appreciated that in practice memories 4A, 4B can be implemented in a single storage structure. Access to database 2 is via a calendar 8, which can be an internal calendar implemented within the processor in a known way. The purpose of the distribution system is to distribute among the policyholders an investment fund 10. It will readily be apparent that the fund 10 is shown here for diagrammatic purposes only. In fact, it can be managed in any appropriate way, either at the same location as or separately from the distribution system. One model for management of the fund is discussed in more detail later. Payments from the fund are determined based on the number of units owned by a policyholder during a vesting period and to that extent the fund is linked with the distribution system. The processor 6 executes a unit allocation process 12 implemented as a computer program. The novel principle underlying unit allocation in the present unit allocation system arises from the allocation of birthday units which are additional units allocated to a policyholder on his/her birthday according to an algorithm discussed in detail below. The fund has a maximum age entry requirement of, for example, 65 and a minimum 10 year period before commencement of a vesting option. Therefore, the age at commencement of the vesting option could be for example 75. The payment period at vesting is set at, for example, 20 years. Birthday units are allocated on birthdays following investment into the fund, both during the initial (ten year) period and after the vesting age. Thus, a policyholder benefits from dual leverage: payments are driven by the dual compounding of investment returns and the mortality of the policyholder pool. As policyholders die, their funds are redistributed as birthday units according to the mortality calculation discussed below to surviving policyholders.

Once policyholders reach their vesting age they receive annual payments for 21 years subject to survival, the payments reflecting the compound growth in the fund plus the increase in units from birthday units.

An aspect of the system involves how to determine the redistribution quota of the fund due to death of policyholders, by allocating extra units to policyholders based on a probability of availability of units in the fund arising from deceased policyholders.

An appropriate (as determined from time to time by the appointed actuary) mortality table 5 stored in the memory 4 is used to calculate expected mortality experience against a standard mortality reference. As shown in FIG. 2, the mortality table holds for each age x the total number of units held by the policyholders at that age Uₓ, the expected probability of death (rate of mortality) qₓ and the expected units for redistribution Uₓ*qₓ. The total expected units available for redistribution from deaths E=ΣUₓ*qₓ. The expected probability of death qₓ is determined from a standard reference table (not shown). Risk factors are periodically reviewed and input to the unit allocation process.

From time to time, typically annually, E is calculated (as above, based on the current situation of the mortality table for policyholders) and a value for A is determined. A is the actual number of units released from deceased policyholders, or it can be smoothed using a rolling five year average of actual mortality experience (or over a period of years since the product was launched if less than five).

The ratio A/E will provide the factor by which the mortality table 5 should be adjusted.

Therefore, if qₓ is the rate of mortality at age x in the reference table, the adjusted rate of mortality q′ₓ is: q′ₓ=(A/E)*qₓ.

The allocation of birthday units will be q′ₓ/(1−q′ₓ) or put another way the surviving policyholders' units will increase in the ratio of 1/(1−(A/E)qₓ).

The allocation to each policy holder is pro-rated based on their unit holding and therefore a survivor will see their unit holding grow from U immediately before their birthday to U/1−qₓ on their birthday. Note that the total number of units remains unchanged, but these are now distributed amongst the surviving group Px=1−qₓ.

This calculation is performed for each policyholder as they reach a birthday as determined by the calendar by the unit allocation process 12. The allocation of birthday units continues from commencement until the death or reaching the maximum payout age whichever the sooner. The process overall continues in perpetuity while the fund continues to cover an in force population of policyholders.

FIG. 3 is a flow chart of the process implemented by the unit allocation process 12 in the processor 6 for policy maintenance. At step S1 the calendar date is checked to determine whether or not it is the birthday of an existing policyholder. If it is determined to be a birthday at step S2, the process moves on to identify the policyholder and allocate birthday units in step S3 in accordance with the allocation algorithm. If it is not a birthday, the process returns to S1. Once the birthday units have been allocated at step S3, the new unit allocation for that policyholder is stored in the database 2.

Birthday units are allocated on a policyholder's birthday following investment into the fund but no payments are received until the vesting age is reached. After that age, twenty-one annual payments (assuming survival of the policyholder) are made according to a table shown in FIG. 4 which shows the percentage of the policyholder's units to be cancelled for the payment in respect of that year. The table is used as an input to a claim processing procedure discussed below which executes payments. The table provides for a monotonic increasing series of payments during disinvestment.

FIG. 5 is a graph showing average UK life expectancy at birth for males and females. FIG. 6 is a table of mortality rates.

Based on these assumptions, FIG. 7 illustrates the effect of the birthday unit allocation policy discussed above on policyholders of the fund, shown in graph (i), as compared with pension schemes or conventional savings shown in graphs (ii) and (iii) respectively.

A fixed disinvestment schedule (FIG. 4) has been constructed to produce a monotonic increasing series of payments throughout the 20 year disinvestment period assuming the actual investment returns and mortality experience are in line with the estimates.

FIG. 8 is a schematic diagram of a high level operating model for implementing the distribution system discussed herein. Reference numeral 100 represents a fund manager who manages the fund 10 which is to be distributed. There could be a plurality of fund managers. The fund manager 100 is in contact with an administration services centre 102. The administration services centre 102 receives information about the birthday unit distribution system from a birthday unit source 106. This is a provider of the birthday unit allocation process discussed hereinabove. The administration services centre 102 is in communication with a contact centre 108 which is the first port of call for new policyholders 110 which can contact the contact centre directly or via an independent financial advisor 112. The administration services centre. 102 communicates with a platform responsible for handling the policies for the policyholders. This is represented by the policy maintenance module 114, and the claims processing module 116. The policy maintenance module 114 is responsible for the allocation of birthday units 114a, statement processing 114b and commission processing 114c. The claims processing module 116 handles payouts at death 116a or during vesting 116b.

According to this model, information concerning the birthday unit allocation algorithm is supplied from the birthday unit source 106 to the administration services centre 102 so that it can be implemented at the policy maintenance module 114. Information about policyholders (the database 2) is held at the administration services centre 102. Payouts are determined at the claims processing module 116 and information about the effect on the fund is returned to the fund manager 100 via the administration services centre to allow him to manage the fund 10 at the new level.

What is claimed is:

1. A method of allocating units in a monetary fund which comprises the steps of:
determining an initial unit allocation for each policyholder of the fund;
periodically allocating extra units to surviving policyholders of the fund, wherein the number of extra units being allocated is based on a probability of availability of units in the fund arising from deceased policyholders.

2. A method according to claim 1, wherein the extra units are distributed amongst policyholders in accordance with likelihood of survival of each policyholder and their current unit holding.

3. A method according to claim 2, wherein the step of allocating extra units is implemented at each birthday of a policyholder.

4. A method according to claim 1, wherein the extra units are distributed amongst policyholders in accordance with their age, policyholder gender and duration since their entry into the monetary fund.

5. A method according to claim 1, wherein a step of determining the number of extra units being allocated calculates a total expected units available for redistribution in accordance with the following algorithm:
E=ΣUₓ*qₓ
where Uₓ is the unit holding of a policyholder at age x and qₓ is the probability of death at age x.

6. A method according to claim 3, wherein qₓ is derived from a standard reference table.

7. A method according to claim 4, in which units are distributed amongst each policyholder in accordance with the following algorithm:
actual distribution at each age x=(A/E)*Uₓ*qₓ/(1−(A/E)*qₓ)
where A is the actual number of units released from deceased policyholders.

8. A method according to claim 5, in which units are distributed amongst each policyholder in accordance with the following algorithm:
actual distribution at each age x=(A/E)*Uₓ*qₓ/(1−(A/E)*qₓ)
where A is the actual number of units released from deceased policyholders.

9. A method of distributing a monetary fund which comprises the steps of:
periodically determining a number of extra units in the fund to be allocated based on a probability of availability of units in the fund arising from deceased policyholders;
distributing the extra units amongst surviving policyholders;
making periodic payments to a policyholder based on their unit allocation at the time a payment is made; and
adjusting their unit allocation.

10. A method according to claim 9, wherein said payments are made according to a schedule constructed to produce a monotonic increasing series of payments.

11. A method according to claim 9, wherein extra units are allocated to each policyholder at each birthday of the policyholder.

12. A method according to claim 9, wherein the step of distributing the extra units amongst surviving policyholders is carried out based on the likelihood of survival and current holding of units of a policyholder.

13. A method according to claim 9, wherein the step of determining the number of extra units being allocated calculate a total expected units available for redistribution in accordance with the following algorithm:
E=ΣUₓ*qₓ
where Uₓ is the unit holding of a policyholder at age x and qₓ is the probability of death at age x.

14. A method according to claim 11, wherein qₓ is derived from a standard reference table.

15. A method according to claim 11, wherein the step of distributing the extra units is carried out in accordance with the following algorithm:
actual distribution at each age x=(A/E)*Uₓ*qₓ/(1−(A/E)*qₓ)
where A is the actual number of units released from deceased policyholders.

16. A method according to claim 12, wherein the step of distributing the extra units is carried out in accordance with the following algorithm:
actual distribution at each age x=(A/E)*Uₓ*qₓ/(1−(A/E)*qₓ)
where A is the actual number of units released from deceased policyholders.

17. A method according to claim 9, in which no payments are made to a policyholder prior to a vesting age of a policyholder.

18. A method according to claim 9, in which no payments are made to a policyholder in a period between an age of entry to the fund and a vesting age.

19. A method according to claim 18, wherein extra units are distributed to surviving policyholders in said period.

20. A processor programmed to allocate units in a monetary fund by executing the steps of:
determining an initial unit allocation for each policyholder of the funds;
determining a number of extra units to be allocated to surviving policyholders of the fund based on a probability of availability of units in the fund arising from deceased policyholders; and
periodically distributing said extra units amongst surviving policyholders.

21. A computer program comprising computer readable instructions which when executed by a computer implements the steps of:
determining an initial unit allocation for each policyholder of the funds;
determining a number of extra units to be allocated to surviving policyholders of the fund based on a probability of availability of units in the fund arising from deceased policyholders; and
periodically distributing said extra units amongst surviving policyholders.

22. A monetary fund distribution system comprising: a processor programmed to determine an initial unit allocation for each policyholder of a fund, and to periodically allocate extra units to surviving policyholders of the fund;
a table holding details of policyholders, their birthdays, age and unit holding;
a calendar for determining birthdays of policyholders for prompting allocation of extra units on each birthday of a policyholder; and
a mortality table holding mortality probabilities whereby the number of extra units which are allocated is based on the probability of availability of units in the fund arising from deceased policyholders.
